(19) United States
(12) Patent Application Publication
(10) Pub. No.: US 2026/0049802 A1
(43) Pub. Date: Feb. 19, 2026

(54) EXTERIOR WINDOW TRIM MEASUREMENT DEVICE

(71) Applicant: Jesse Carpenter, Pinckney, MI (US)

(72) Inventor: Jesse Carpenter, Pinckney, MI (US)

(21) Appl. No.: 19/297,669

(22) Filed: Aug. 12, 2025

Related U.S. Application Data
(60) Provisional application No. 63/683,731, filed on Aug. 16, 2024.

(51) Int. Cl. G01B 3/04

(52) U.S. Cl. CPC G01B 3/04

(57) ABSTRACT

Disclosed herein are measurement devices comprising a plurality of slides and measurement arms. The measurement device includes a first slide, a second slide, a third slide, and a fourth slide, each slide having a receptacle defining a passageway and a pivot assembly. The first pivot assembly is mated with the second pivot assembly to pivotally attach the first slide to the second slide. The third pivot assembly is mated with the fourth pivot assembly to pivotally attach the third slide to the fourth slide. The slides are movably disposed on one or more measurement arms.

### CROSS-REFERENCE TO RELATED APPLICATION

This application claims the benefit of co-pending U.S. Provisional Patent Application No. 63/683,731, filed Aug. 16, 2024, for “Exterior Window Trim Measurement Device,” which is hereby incorporated by reference in its entirety including the drawings.

### BACKGROUND OF THE INVENTION

The present disclosure generally relates to embodiments and methods for measuring exterior window trims.

The installation of a window is a difficult process. An opening is usually first planned and built within a wall so the window can fit within the opening and be installed. The opening is often designed and built larger than the window, leaving vacant space around one or more sides of the window when it is installed. This vacant space is increased as a precaution so that the window is more likely to fit into the opening in the wall.

When fully installed, this vacant space is covered by an exterior trim along the edges of the window. The trim should be measured precisely and bent to fit over the vacant space between the window and the wall. The trim should be adjacent to the window, block sight of the vacant space, and be adjacent to the wall. The part of the trim which is parallel to the wall, blocking the vacant space, is commonly called a “face”. The part of the trim adjacent to the window and sharing an edge with the face is commonly called a “come-out”. The part of the trim adjacent to the wall of the building and sharing an edge with the face is commonly called a “return”. The come-out and the return share edges with the face that are around 90-degree angles. The come-out and the return are relatively perpendicular to the wall and the face is relatively parallel to the wall, making the trim form a “C” shape commonly called a “C-bend”. This trim may be made of expensive metals and any inaccurate measurements can lead to a waste of material and time. Therefore, precise measurements of trims are needed in a timely manner.

### SUMMARY OF THE INVENTION

Described herein is a measurement device comprising slides that have receptacles and pivot assemblies. The receptacles define passageways in which measurement arms can be inserted. The pivot assemblies are mated with other pivot assemblies on other slides which, in turn, attach a slide to another slide. The pivot assemblies allow attached slides to rotate independently. A first slide may be movably disposed on a first measurement arm. A second slide and a third slide may be movably disposed on a second measurement arm. A fourth slide may be movably disposed on a third measurement arm. The measurement arms may be rotated independently, by way of the slides, to form a closed configuration of the measurement device. The measurement arms may be rotated independently, by way of the slides, to form an open configuration of the measurement device.

A first pivot assembly may be mated with a second pivot assembly to pivotally attach the first slide to the second slide. A third pivot assembly may be mated with the fourth pivot assembly to pivotally attach the third slide to the fourth slide. A first slide may be movably disposed on a first measurement arm. A second slide and a third slide may be movably disposed on a second measurement arm. A fourth slide may be movably disposed on a third measurement arm. The first passageway and first measurement arm may be orthogonal to the second passageway, third passageway, fourth passageway, second measurement arm, and third measurement arm.

The first slide and the second slide may easily pivot to around 90 degrees and the third slide and the second slide may easily pivot to around 90 degrees, forming an open configuration of the measurement device. The first measurement arm can be inserted into a trim track and the first slide can be adjusted to reach a desired come-out distance. The second measurement arm may be adjusted within the second and third passageway to reach a desired face distance. The third measurement arm can be adjusted to reach a desired return distance.

The quick and accurate measurement of these three distances can provide an accurate number of materials needed and the location of around 90-degree bends in order to produce an exterior window trim in a fast and efficient manner.

In one embodiment, a measurement device includes a first slide having a first receptacle and a first pivot assembly, a second slide having a second receptacle and a second pivot assembly, a third slide having a third receptacle and a third pivot assembly, and a fourth slide having a fourth receptacle and a fourth pivot assembly, wherein each receptacle defines a passageway. The first pivot assembly is mated with the second pivot assembly to pivotally attach the first slide to the second slide and the third pivot assembly is mated with the fourth pivot assembly to pivotally attach the third slide to the fourth slide. The first slide is movably disposed on a first measurement arm, the third slide is movably disposed on a second measurement arm, and the fourth slide is movably disposed on a third measurement arm.

In another embodiment, a measurement device includes a first slide and a second slide, each having a pivot assembly and a receptacle defining a passageway, and a third slide and a fourth slide, each having a pivot assembly and receptacle defining a passageway. The first and second pivot assemblies, as well as the third and fourth pivot assemblies, are attached and independently rotatable. The first slide and second slide are in a mated position when the measurement device is in an open configuration and in a closed configuration and the third slide and fourth slide are in a mated position when the measurement device is in an open configuration and in a closed configuration. The first pivot assembly and the second pivot assembly are in a mated position at angles of equal to or greater than 80 degree increments and less than or equal to 100 degree increments in rotation and in a partially mated position between the angles of equal to or greater than 80 degree increments and less than or equal to 100 degree increments in rotation. The third pivot assembly and the fourth pivot assembly are in a mated position at angles of equal to or greater than 80 degree increments and less than or equal to 100 degree increments in rotation and in a partially mated position between the angles of equal to or greater than 80 degree increments and less than or equal to 100 degree increments in rotation.

In yet another embodiment, a measurement device comprises a handle, a first measurement arm disposed on the handle, a second measurement arm, and a third measurement arm. The device further includes a first slide, second slide, third slide, and fourth slide, each having a passageway, with the first slide and the second slide pivotally attached and movably disposed on the measurement arms and the third slide and the fourth slide pivotally attached and movably disposed on the measurement arms. The first measurement arm is configured to fit within a trim track of a window and contact an end of the trim track, while the third measurement arm is configured to contact an exterior of a building. The measurement device may pivot such that central axes of the measurement arms are parallel. In an open configuration the central axis of the first measurement arm is parallel to the central axis of the third measurement arm, while the central axis of the second measurement arm is perpendicular to the first measurement arm and the third measurement arm.

These and additional features provided by the embodiments described herein will be more fully understood in view of the following detailed description, in conjunction with the drawings.

### BRIEF DESCRIPTION OF THE DRAWINGS

FIG. 1 illustrates an example measurement device in a closed or deactivated configuration, according to one or more embodiments shown and described herein;

FIG. 2 illustrates an example measurement device in an open or activated configuration, according to one or more embodiments shown and described herein;

FIG. 3 illustrates a first slide mated with a second slide in a closed or deactivated configuration, according to one or more embodiments shown and described herein;

FIG. 4 illustrates a third slide mated with a fourth slide in a closed or deactivated configuration, according to one or more embodiments shown and described herein;

FIG. 5 illustrates a first slide mated with a second slide in an open or activated configuration, according to one or more embodiments shown and described herein;

FIG. 6 illustrates a third slide mated with a fourth slide in an open or activated configuration, according to one or more embodiments shown and described herein;

FIG. 7 illustrates a first slide having a first receptacle and a first pivot assembly, according to one or more embodiments shown and described herein;

FIG. 8 illustrates a second slide in an upside-down position having a second receptacle and a second pivot assembly, according to one or more embodiments shown and described herein;

FIG. 9 illustrates two side views of the first slide, according to one or more embodiments shown and described herein;

FIG. 10 illustrates two side views of the second slide, according to one or more embodiments shown and described herein;

FIG. 11 illustrates a third slide having a third receptacle and a third pivot assembly, according to one or more embodiments shown and described herein;

FIG. 12 illustrates a fourth slide in an upside-down position having a fourth receptacle and a fourth pivot assembly, according to one or more embodiments shown and described herein;

FIG. 13 illustrates two side views of the third slide, according to one or more embodiments shown and described herein;

FIG. 14 illustrates two side views of the fourth slide, according to one or more embodiments shown and described herein;

FIG. 15 illustrates top views of the four slides, the window, and the wall, according to one or more embodiments shown and described herein;

FIG. 16 illustrates an example measurement device having two slides, according to one or more embodiments shown and described herein;

FIG. 17 illustrates an example measurement device having two slides, according to one or more embodiments shown and described herein;

FIG. 18 illustrates an example measurement device that can include three parallel measurement arms, according to one or more embodiments shown and described herein;

FIG. 19 illustrates an example measurement device including a screen showing one combined measurement, according to one or more embodiments shown and described herein; and

FIG. 20 illustrates an example measurement device including a screen showing three separate measurements, according to one or more embodiments shown and described herein.

### DETAILED DESCRIPTION

As used in this disclosure, certain terms have the meanings ascribed below. The term “C-bend” means the shape of a sheet of metal with two bends of about 90 degrees. The term “trim” means a metal C-bend on the exterior of a building, contacting the window, covering any vacant space between the window and the wall, and adjacent to the wall. The term “measurement arm” means any device with measurement annotations such as a ruler, combination square, or tape measure. The term “trim track” means a closed-end passageway along the edge of the window that can fit a measurement arm or a trim. The term “face” is the part of the trim, relatively parallel to the window and the wall, blocking the vacant space between the window and the wall. The term “come-out” is the part of the trim contacting the window in the trim track and sharing an edge with the face at an about 90-degree bend. The term “return” is the part of the trim adjacent to the wall of the building, sharing an edge with the face at an about 90-degree bend, and relatively parallel to the come-out.

Where a closed or open-ended numerical range is described herein, all values and subranges within or encompassed by the numerical range are to be considered as being specifically included in and belonging to the original disclosure of the present application as if these values and subranges had been explicitly written out in their entirety. The upper and lower limits of all numerical ranges are deemed to be preceded by the modifier “about.”

All patent applications, patent application publications, patents, scientific and technological literature, publications, and references specifically mentioned herein are incorporated herein by reference in their entirety.

This detailed description and the appended drawings describe and illustrate various example measurement devices. The description and illustration of these examples are provided to enable one skilled in the art to make and use measurement devices, such as rulers, combination squares, and tape measures. The inclusion of detailed descriptions of these examples is not intended to limit the scope of the invention, or its protection, in any manner. The presently described measurement device and methods are capable of being practiced or carried out in various ways and the examples described and illustrated herein are not considered exhaustive.

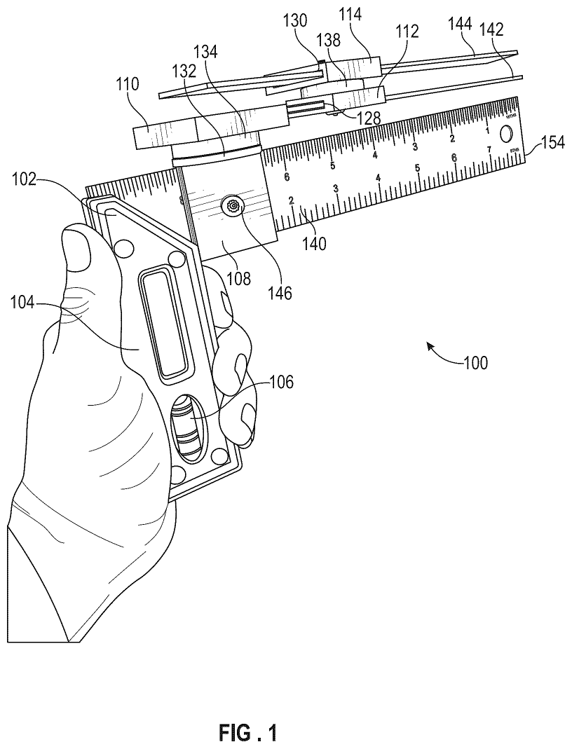

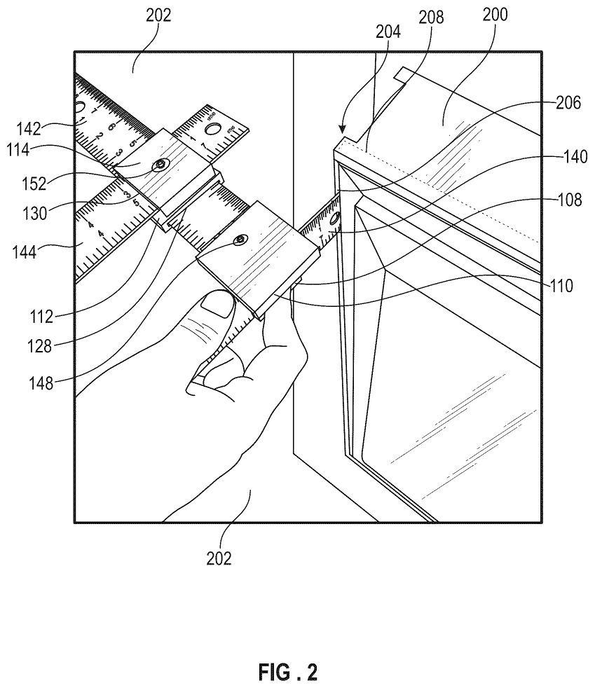

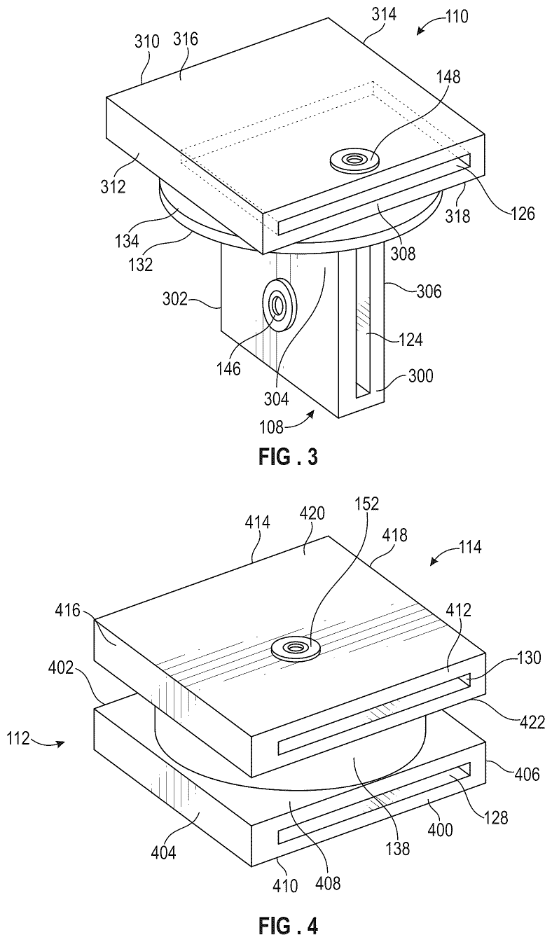

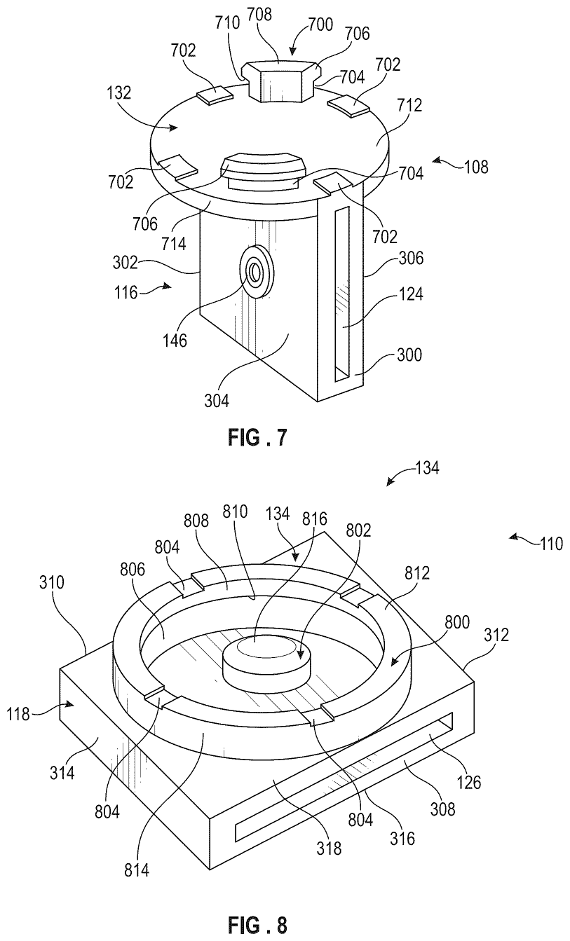

FIGS. 1 through 15 illustrate a first embodiment of a measurement device 100. FIG. 1 illustrates the measurement device 100 in a closed or deactivated configuration while FIG. 2 illustrates the measurement device 100 in an opened or activated configuration. As further illustrated in FIGS. 1 and 2, the measurement device 100 includes a first slide 108, a second slide 110, a third slide 112, and a fourth slide 114. FIGS. 3, 5, 7, 8, 9, and 10 illustrate either the first slide 108, the second slide 110, or both. The first slide 108 may include a first receptacle 116, a first clamp 146, and a first pivot assembly 132. Referring to FIG. 7, the first receptacle 116 defines a first passageway 124 through the first slide 108 and is configured to accept a first measurement arm 140. The first measurement arm 140 includes a first measurement arm end 154. The first slide 108 is allowed to freely actuate on the first measurement arm 140. The first clamp 146 is within the first receptacle 116 and configured to narrow the first passageway 124. Narrowing of the first passageway 124 by the first clamp 146 may prevent actuation of the first slide 108 on the first measurement arm 140. FIG. 1 illustrates a combination square 102 being used as a first measurement arm 140, although other measurements arms such as a ruler or a tape measure may be used. The first passageway 124 may be configured to allow actuation and clamping when other measurement arms are used. A level 106 is also integrated into a handle 104 of the combination square 102 to assist in measurement.

FIGS. 1, 2, 3, 5 and 8 illustrate a second slide 110. Referring to FIG. 8, the second slide 110 may include a second receptacle 118, a second clamp 148, and the second pivot assembly 134. The second receptacle 118 defines a second passageway 126 inside the second slide 110 and configured to accept a second measurement arm 142. The second measurement arm 142 may be inserted into the second passageway 126 of the second slide 110 until it reaches the end of the second passageway 126. The second clamp 148 is within the second receptacle 118 and configured to narrow the second passageway 126. Narrowing of the second passageway 126 by the second clamp 148 may prevent actuation of the second measurement arm 142 within the second passageway 126. FIG. 1 illustrates a ruler as the second measurement arm 142 although other measurement arms may be used. The second passageway 126 may be configured to allow actuation and clamping when other measurement arms are used. The second pivot assembly 134 is configured to mate with the first pivot assembly 132.

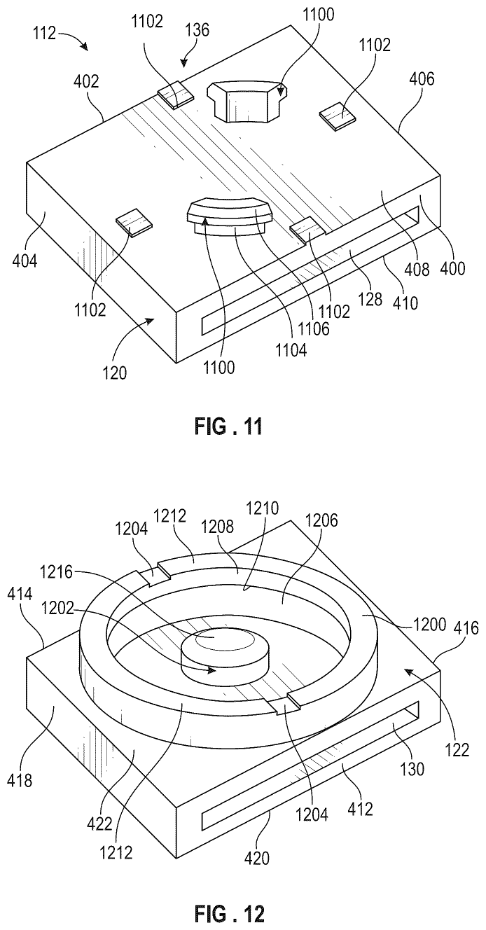

FIGS. 1, 2, 4, and 6 illustrate a third slide 112. Referring to FIG. 11, the third slide 112 may include a third receptacle 120, a third clamp 150, and a third pivot assembly 136. The third receptacle 120 defines a third passageway 128 through the third slide 112 and is configured to accept the second measurement arm 142. The third slide 112 may freely actuate on the second measurement arm 142. The third clamp 150 is within the third receptacle 120 and configured to narrow the third passageway 128. Narrowing of the third passageway 128 by the third clamp 150 may prevent actuation of the third slide 112 on the second measurement arm 142. FIG. 1 illustrates a ruler as the second measurement arm 142 although other measurement arms may be used. The third passageway 128 may be configured to allow actuation and clamping when other measurement arms are used. The third pivot assembly 136 is configured to mate with a fourth pivot assembly 138.

FIGS. 1, 2, 4, 6, 12, and 14 illustrate a fourth slide 114 in an upside-down position. Referring to FIG. 11, FIG. 1 illustrates a fourth slide 114. The fourth slide 114 may include a fourth receptacle 122, a fourth clamp 152, and a fourth pivot assembly 138. The fourth receptacle 122 defines a fourth passageway 130 through the fourth slide 114 and is configured to accept a third measurement arm 144. The third measurement arm 144 is allowed to freely actuate inside the fourth passageway 130. The fourth clamp 152 is within the fourth receptacle 122 and configured to narrow the fourth passageway 130. Narrowing of the fourth passageway 130 by the fourth clamp 152 may prevent actuation of the third measurement arm 144 within the fourth passageway 130. FIG. 1 illustrates a ruler as the third measurement arm 144 although other measurement arms may be used. The fourth passageway 130 may be configured to allow actuation and clamping when other measurement arms are used. The fourth pivot assembly 138 is configured to mate with the third pivot assembly 136.

The measurement device 100 may pivot between a closed configuration or what may be referred to as a deactivated configuration and an open configuration or what may be referred to as an activated configuration. FIG. 1 illustrates the measurement device 100 in a closed or deactivated configuration. In the closed or deactivated configuration, the central axes of all three measurement arms are parallel. The first pivot assembly 132 and second pivot assembly 134 are mated and the third pivot assembly 136 and fourth pivot assembly 138 are mated. The first passageway 124 may be on an orthogonal plane in comparison to the second passageway 126, third passageway 128, and fourth passageway 130. The second passageway 126 and third passageway 128 are on the same plane and are on a parallel plane with the fourth passageway 130. The first pivot assembly 132 and second pivot assembly 134 may be mated at a range of around 90-degree angles in full rotation with respect to the closed or deactivated configuration illustrated in FIG. 1 and partially mated elsewhere. The range of around 90-degree angles is equal to or greater than 80 degrees and less than or equal to 100 degrees. The third pivot assembly 136 and fourth pivot assembly 138 may be mated at around 90-degree angles in full rotation with respect to the closed or deactivated configuration illustrated in FIG. 1 and partially mated elsewhere. This range of around 90-degree angles is also equal to or greater than 80 degrees and less than or equal to 100 degrees. The ability of the third slide 112 to mate at a ranges of an about 90-degree angle allows a user of the measurement device 100 to insert measurement arms in either direction of each passageway. The pivot assemblies 132, 134, 136, 138 are configured to hold in rotation when mated at around 90-degree angles. Slight rotating pressure may adjust the pivot assemblies 132, 134, 136, 138 to a partially mated state. Slight rotating pressure may also rotate the pivot assemblies 132, 134, 136, 138 with respect to each other while in a partially mated state. The ability to rotate with only slight rotating pressure and the ability to adjust the clamps allows a user to easily operate the measurement device 100 with both hands gaining a total measurement of the combination of the come-out, the face, and the return.

FIG. 2 illustrates the measurement device 100 in an open configuration which may also be called an activated configuration. The first slide 108 and the second slide 110 are mated so that the central axes of the first passageway 124 and the second passageway 126 are at an about 90-degree angle. The third slide 112 and the fourth slide 114 are mated so that the central axes of the third passageway 128 and the fourth passageway 130 are at an about 90-degree angle. The open or activated configuration is aligned so that the central axes of the first measurement arm 140 and the third measurement arm 144 are parallel while the central axis of the second measurement arm 142 is perpendicular to the central axes of the first measurement arm 140 and the third measurement arm 144.

FIG. 2 illustrates a window 200 including a trim track 206 and a wall 202. The trim track 206 is along the edge of the window 200. A vacant space 204 is shown between the window 200 and the wall 202. The measurement device 100 is in contact with the window 200 and the wall 202. The first measurement arm 140 is inserted into the trim track 206 of the window 200. The third measurement arm 144 is contacting the wall 202. FIG. 2 illustrates the second clamp 148 and the fourth clamp 152 in activated positions while the first clamp 146 and the third clamp 150 are not in view but also in activated positions. Actuation of the first slide 108 on the first measurement arm 140 is prevented as the first clamp 146 is activated. Actuation of the second measurement arm 142 within the second passageway 126 is prevented as the second clamp 148 is activated. Actuation of the third slide 112 on the second measurement arm 142 is prevented as the third clamp 150 is activated. Actuation of the third measurement arm 144 is prevented as the fourth clamp 152 is activated. The measurement device 100 is configured to allow easy reading of measurement annotations on the measurement arms 140, 142, 144 when the measurement arms 140, 142, 144 and slides 108, 110, 112, 114 are prevented from actuation.

Multiple methods exist for actuation of slides 108, 110, 112, 114 and measurement arms 140, 142, 144 when transitioning between a closed configuration or deactivated configuration and an open or activated configuration. The steps within different methods may be taken in different arrangements to receive the same final measurement result. One method that can be used to make the transition is described. Assuming all clamps 146, 148, 150, 152 are activated, the first step is the rotation of the mated first slide 108 and second slide 110 into a partially mated position and continuing the rotation until the first slide 108 and second slide 110 again become mated at a range of an about 90-degree angle. Next the first measurement arm 140 is inserted into a trim track 206 until the first measurement arm end 154 is touching the trim track end 208. Next, the first clamp 146 is deactivated causing the first slide 108 to become free to actuate on the first measurement arm 140. Next, the first slide 108 is actuated on the first measurement arm 140 until a desired come-out distance 1504 is reached. Next, the first clamp 146 is activated preventing actuation of the first slide 108. Next, the third clamp 150 is deactivated causing the third slide 112 to become free to actuate on the second measurement arm 142. Next, the third slide 112 is actuated on the second measurement arm 142 until a desired face distance 1506 is reached. Next, the third clamp 150 is activated preventing actuation of the third slide 112. The next step is rotation of the mated third slide 112 and fourth slide 114 into an unmated position and continuing the rotation until the third slide 112 and fourth slide 114 again become mated at a range of an about 90-degree angle. Next, the fourth clamp 152 is deactivated causing the third measurement arm 144 to become free to actuate within the fourth passageway 130. Next, the third measurement arm 144 is actuated within the fourth passageway 130 until the end of the third measurement arm 144 is adjacent to the wall 202, determining a desired return distance 1508. Next, the fourth clamp 152 is activated preventing actuation of the third measurement arm 144. Next, the first measurement arm 140 may be removed from the trim track 206. Final measurements of come-out distance 1504, face distance 1506, and return distance 1508 are displayed on the measurement device 100. These measurements may be displayed on the measurement arms, digitally displayed individually, digitally displayed accumulated, and displayed in other ways.

FIG. 3 illustrates the first slide 108 mated with the second slide 110 in a closed or deactivated configuration. The first slide 108 includes the first receptacle 116, the first pivot assembly 132, a first receptacle first side 304, and a first receptacle second side 306. The first receptacle 116 includes a first receptacle first end 300 and a first receptacle second end 302. The first passageway 124 is an open passageway through the first receptacle 116 from the first receptacle first end 300 to the first receptacle second end 302. The first measurement arm 140 may fit inside the first passageway 124. The first receptacle first side 304 includes the first clamp 146. The first clamp 146 may narrow the first passageway 124 when activated, preventing actuation of the first slide 108 on the first measurement arm 140.

FIG. 3 illustrates the second slide 110 including the second receptacle 118 and a second pivot assembly 134. The first pivot assembly 132 is mated with the second pivot assembly 134 in a closed or deactivated configuration. The second receptacle 118 includes a second receptacle first end 308, a second receptacle second end 310, a second receptacle first side 312, a second receptacle second side 314, a second receptacle top 316, and a second receptacle bottom 318. The second passageway 126 is a closed-end passageway from the second receptacle first end 308 to halfway between the second receptacle first end 308 and the 310. The second passageway 126 is between the second receptacle first end 308 and the second receptacle second end 310. The second receptacle top 316 includes the second clamp 148, which can be a simple screw. The second clamp 148 may narrow the second passageway 126 when activated, preventing actuation of the second measurement arm 142 in the second passageway 126.

FIG. 4 illustrates the third slide 112 mated with the fourth slide 114 in a closed or deactivated configuration. The third slide 112 includes a third receptacle 120 and third pivot assembly 136. The third receptacle 120 includes a third receptacle first end 400, a third receptacle second end 402, a third receptacle first side 404, a third receptacle second side 406, a third receptacle top 408, and a third receptacle bottom 410. The third passageway 128 is an open passageway through the third receptable from the third receptacle first end 400 to the third receptacle second end 402. The second measurement arm 142 may fit the third passageway 128. The third receptacle bottom 410 includes the third clamp 150 inside. However, it cannot be seen under the third receptacle 120 in the angle shown in FIG. 4. The third clamp 150 may narrow the third passageway 128 when activated preventing actuation of the third slide 112 on the second measurement arm 142.

FIG. 4 further illustrates the fourth slide 114 including a fourth receptacle 122 and a fourth pivot assembly 138. The third pivot assembly 136 is mated with the fourth pivot assembly 138 in a closed or deactivated configuration. The fourth receptacle 122 includes a fourth receptacle first end 412, a fourth receptacle second end 414, a fourth receptacle first side 416, a fourth receptacle second side 418, a fourth receptacle top 420, and a fourth receptacle bottom 422. The fourth passageway 130 is an open passageway through the fourth receptacle 122 from the fourth receptacle first end 412 to the fourth receptacle second end 414. The fourth receptacle top 420 includes the fourth clamp 152. The fourth clamp 152 may narrow the fourth passageway 130 when activated, preventing actuation of a third measurement arm 144 in the fourth passageway 130.

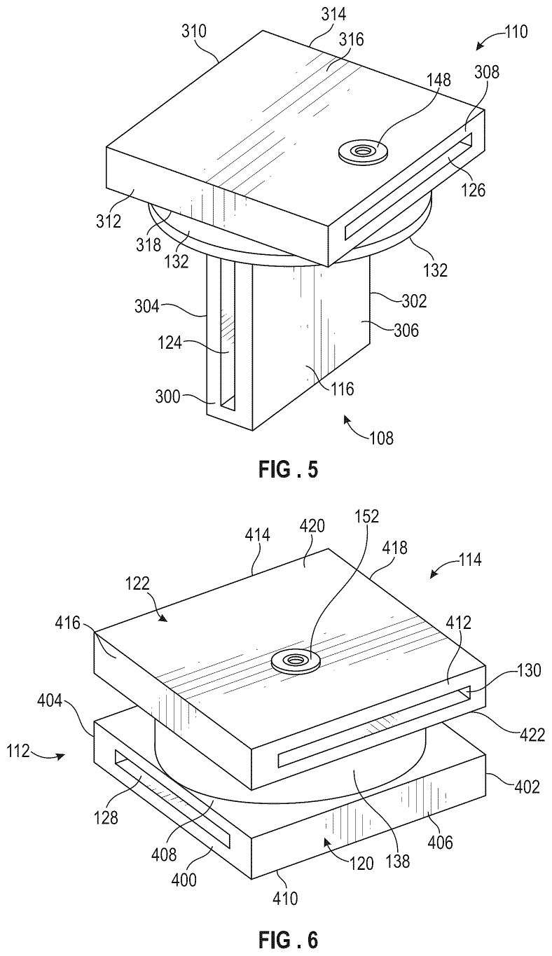

FIG. 5 illustrates the first slide 108 mated with the second slide 110 in an open or activated configuration. The first slide 108 includes a first receptacle 116 and first pivot assembly 132. The second slide 110 includes a second receptacle 118 and second pivot assembly 134. The first pivot assembly 132 is mated with the second pivot assembly 134 in an open or activated configuration. The plane of the fourth receptacle first end 412 is generally perpendicular to the second passageway 126. The first clamp 146 is not shown in FIG. 5 as it is on the first receptacle first side 304. The first clamp 146 travels from the first receptacle first side 304 to the first passageway 124 leaving an open space to fit multiple types of clamping mechanisms such as a threaded insert and screw. The second passageway 126 is a closed-end passageway that travels through the second receptacle 118 and ends halfway between the second receptacle first end 308 and the second receptacle second end 310. In this open configuration, this halfway point shares a plane with the first passageway 124. The second clamp 148 is on the second receptacle top 316. The second clamp 148 travels from the first receptacle first side 304 to the second passageway 126 leaving an open space to fit multiple types of clamping mechanisms such as a threaded insert and screw.

FIG. 6 illustrates the third slide 112 mated with the fourth slide 114 in an open or activated configuration. The third slide 112 includes a third receptacle 120 and third pivot assembly 136. The fourth slide 114 includes a fourth receptacle 122 and fourth pivot assembly 138. The third pivot assembly 136 is mated with the fourth pivot assembly 138 in an open or activated configuration. The third pivot assembly 136 cannot be seen in FIG. 6 as the fourth pivot assembly 138 is covering it when they are mated. The third clamp 150 is not shown in FIG. 6 as it is on the third receptacle bottom 410. The third clamp 150 travels from the third receptacle bottom 410 to the third passageway 128 leaving an open space to fit multiple types of clamping mechanisms such as a threaded insert and screw. The fourth clamp 152 is on the fourth receptacle top 420. The fourth clamp 152 travels from the fourth receptacle top 420 to the fourth passageway 130 leaving an open space to fit multiple types of clamping mechanisms such as a threaded insert and screw.

FIG. 7 illustrates the first slide 108 including the first receptacle 116 and the first pivot assembly 132. The first pivot assembly 132 includes a first pivot assembly coupling 700, a first pivot assembly convex ridge 702, a first pivot assembly top surface 712, and a first pivot assembly outer surface 714. The first pivot assembly couplings 700 include a first pivot assembly coupling first outer surface 704, a first pivot assembly coupling second outer surface 706, a first pivot assembly coupling top surface 708, and a first pivot assembly coupling bottom surface 710. The two first pivot assembly couplings 700 are separated at around 180-degrees increments with respect to the first pivot assembly coupling second outer surface 706. The four first pivot assembly convex ridges 702 are separated at around 90-degree increments with respect to the first pivot assembly coupling second outer surface 706.

FIG. 8 illustrates an upside-down angle of the second slide 110 including the second receptacle 118 and the second pivot assembly 134. The second pivot assembly 134 includes a second pivot assembly collar 800 and a second pivot assembly plug 802. The second pivot assembly collar 800 includes at least one second pivot assembly collar concave groove 804, a second pivot assembly collar first inner surface 806, a second pivot assembly collar second inner surface 808, a second pivot assembly collar top surface 810, a second pivot assembly collar bottom surface 812, and a second pivot assembly collar outer surface 814. The second pivot assembly plug 802 is a cylindrical unit that tapers to a thinner diameter into a second pivot assembly plug bottom surface 816. The second pivot assembly plug 802 is disposed within the second pivot assembly collar 800. As shown in FIG. 8, the second pivot assembly plug 802 may be concentric with the second pivot assembly collar 800.

In a mated position or a partially mated position, the first pivot assembly 132 contacts the second pivot assembly 134. In either position, the first pivot assembly coupling first outer surface 704 is in contact with the second pivot assembly collar second inner surface 808 and the first pivot assembly coupling second outer surface 706 is in contact with the second pivot assembly collar first inner surface 806. In an open or activated configuration and in a close or deactivated configuration, the first pivot assembly convex ridges 702 are mated with the second pivot assembly collar concave grooves 804 and the first pivot assembly top surface 712 is in contact with the second pivot assembly plug bottom surface 816. The embodiment in FIGS. 7 and 8 are shown able to mate at 90-degree increments although alternate configurations. They may mate at other positions such as ranges of about 45-degree increments. When first slide 108 and second slide 110 in FIGS. 7 and 8 are in a partially mated position, the first pivot assembly convex ridges 702 are in contact with the second pivot assembly collar top surface 810. In this embodiment, a change from a mated position to a partially mated position can be made by applying a slight force.

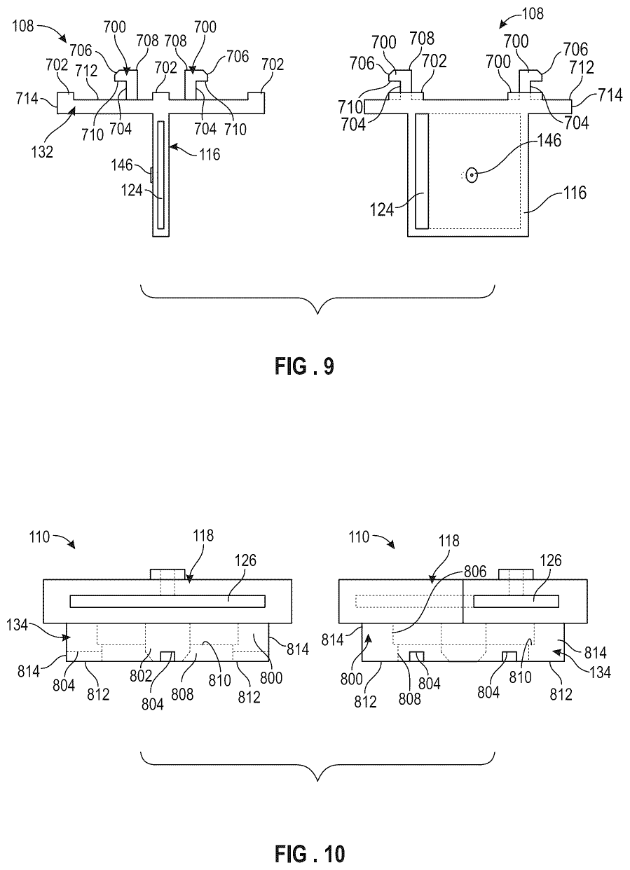

FIG. 9 illustrates the first slide 108 in two side views. The view on the left illustrates a side view of the first slide 108 down the central axis of the first passageway 124. The two first pivot assembly convex ridges 702 visible in the side view are shown on a higher plane than the first pivot assembly top surface 712. The first pivot assembly convex ridges 702 share an exterior edge with the first pivot assembly 132. In this view, two other first pivot assembly convex ridges 702 overlap each other and are not in the side view on the left in FIG. 9. The first pivot assembly convex ridges 702 share a plane with the first pivot assembly outer surface 714. The two first pivot assembly convex ridges 702 not in the side view are in the same plane as the central axis of the first passageway 124. Two first pivot assembly couplings 700 can be seen in the side view, one in the foreground and one in the background.

In the view on the right of FIG. 9 the first slide 108 is at an about 45-degree angle. The two first pivot assembly couplings 700 are within the side view in this angle. All four first pivot assembly convex ridges 702 are not in the side view on the right. Two first pivot assembly convex ridges 702 can be seen in the foreground both overlapping the first pivot assembly convex ridges 702 in the background. The first pivot assembly coupling bottom surface 710 visible in the side view on the right in FIG. 9 is shown on a higher plane than the first pivot assembly convex ridges 702. The first pivot assembly coupling second outer surface 706 does not reach the plane of the first pivot assembly outer surface 714.

FIG. 10 illustrates the second slide 110 in two side views. The view on the left illustrates a side view of the second slide 110 down the central axis of the second passageway 126. This section includes the second pivot assembly collar concave grooves 804. The second pivot assembly collar bottom surface 812 is on the same plane as the second pivot assembly collar outer surface 814. In this view, two other second pivot assembly collar concave grooves 804 overlap each other and are not in the side view as one is in the foreground and one is in the background. The second pivot assembly collar concave grooves 804 are in the same plane as the central axis of the second passageway 126.

In the view on the right of FIG. 10 the second slide 110 is at an about 45-degree angle. The second pivot assembly collar 800 is within the side view in this angle without the second pivot assembly collar concave grooves 804. All four second pivot assembly collar concave grooves 804 are not in the side view on the right. Two second pivot assembly collar concave grooves 804 can be seen in the foreground both overlapping the second pivot assembly collar concave grooves 804 in the background. The view on the right of FIG. 10 illustrates the second passageway 126 with a closed-end at the about 45-degree angle.

FIG. 11 illustrates a third slide 112 having the third receptacle 120 and the third pivot assembly 136. The third pivot assembly 136 includes third pivot assembly couplings 1100 and third pivot assembly convex ridges 1102. The third pivot assembly couplings 1100 and third pivot assembly convex ridges 1102 are attached to third receptacle top 408. The third pivot assembly couplings 1100 are partially curved. The third pivot assembly coupling 1100 has a third pivot assembly coupling first outer surface 1104, third pivot assembly coupling second outer surface 1106, third pivot assembly coupling top surface 1108, and third pivot assembly coupling bottom surface 1110. The width of the third pivot assembly coupling first outer surface 1104 is less than the width of the third pivot assembly coupling second outer surface 1106. The distance between third receptacle first end 400 and third receptacle second end 402 is shorter than the distance between third receptacle first side 404 and third receptacle second side 406. One third pivot assembly convex ridges 1102 shares a face with third receptacle first end 400. One third pivot assembly convex ridges 1102 shares a face with third receptacle second end 402. The distance between both opposing third pivot assembly convex ridges 1102 is the same.

FIG. 12 illustrates an upside-down angle of the fourth slide 114 having a fourth receptacle 122 and a fourth pivot assembly 138. The fourth pivot assembly 138 includes a fourth pivot assembly collar 1200, fourth pivot assembly plug 1202, and fourth pivot assembly concave grooves 1204. The fourth pivot assembly collar 1200 and the fourth pivot assembly plug 1202 are attached to the fourth receptacle bottom 422. The fourth pivot assembly collar 1200 includes a fourth pivot assembly collar first inner surface 1206, fourth pivot assembly collar second inner surface 1208, fourth pivot assembly collar top surface 1210, and fourth pivot assembly collar bottom surface 1212. The fourth pivot assembly collar 1200 has a circular parameter. The fourth pivot assembly collar first inner surface 1206 has a diameter longer than the fourth pivot assembly collar second inner surface 1208. The fourth pivot assembly collar bottom surface 1212 is relatively parallel to the fourth receptacle top 420 and fourth receptacle bottom 422. The fourth pivot assembly plug 1202 is a cylindrical unit that includes a fourth pivot assembly plug bottom surface 1216. The fourth pivot assembly plug 1202 tapers to a thinner diameter into a fourth pivot assembly plug bottom surface 1216. The fourth pivot assembly concave grooves 1204 are concaved into fourth pivot assembly collar 1200 at a higher plane that the fourth pivot assembly collar bottom surface 1212 at around 90-degree increments throughout the fourth pivot assembly collar 1200. The distance between the fourth receptacle first end 412 and the fourth receptacle second end 414 is shorter than the distance between the fourth receptacle first side 416 and the fourth receptacle second side 418. The distance between the fourth receptacle first end 412 and the fourth receptacle second end 414 is equal to the diameter of the fourth pivot assembly collar 1200.

In a mated position or a partially mated position, the third pivot assembly 136 contacts the fourth pivot assembly 138. This can be seen in FIG. 6. In either position, the third pivot assembly coupling first outer surface 1104 is in contact with the fourth pivot assembly collar second inner surface 1208 and the third pivot assembly coupling second outer surface 1106 is in contact with the fourth pivot assembly collar first inner surface 1206. In an open or activated configuration and in a close or deactivated configuration, the third pivot assembly convex ridges 1102 are mated with the fourth pivot assembly collar concave grooves 1204, and the third pivot assembly coupling top surface 1108 is in contact with the fourth pivot assembly plug bottom surface 1216. The first embodiment shows mating at a ranges of about 90-degree increments although alternate configurations may mate at other positions with more ridges and grooves such as eight ridges and eight grooves at ranges of about 45-degree increments. When the third slide 112 and fourth slide 114 are in a partially mated position, the third pivot assembly convex ridges 1102 are in contact with the fourth pivot assembly collar top surface 1210. In this embodiment, a change from a mated position or a partially mated position can be made by applying a slight force.

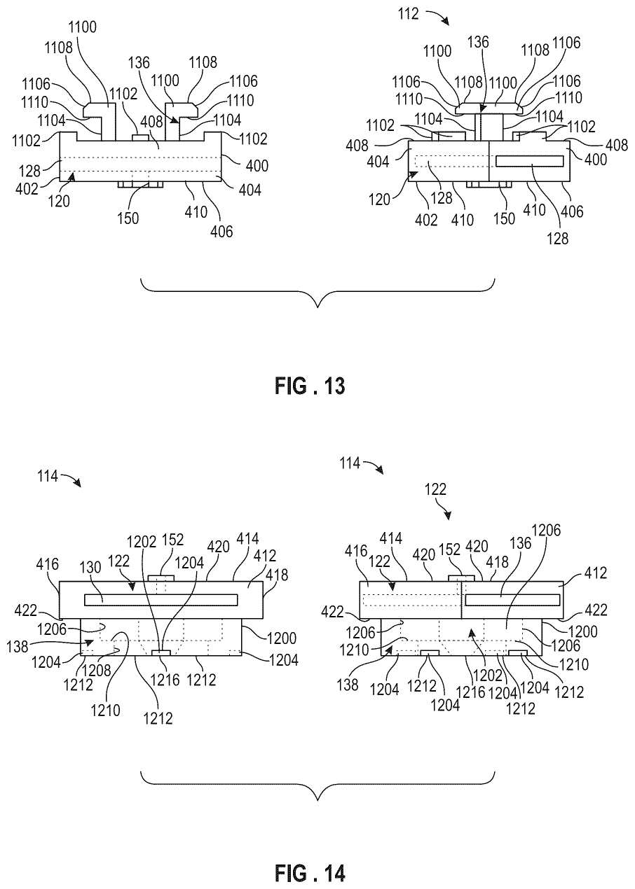

FIG. 13 illustrates two side views of the third slide 112. The left side view illustrates the third slide 112 down the central axis of the third passageway 128. One third pivot assembly convex ridges 1102 shares a face with third receptacle first end 400 and one third pivot assembly convex ridges 1102 share a face with third receptacle second end 402. The third pivot assembly convex ridges 1102 in the middle of FIG. 13 are spaced apart from third receptacle first side 404. FIG. 13 illustrates two third pivot assembly couplings 1100. The width of the third pivot assembly coupling second outer surface 1106 on these two third pivot assembly couplings 1100 is greater than the width of the third pivot assembly coupling first outer surface 1104 on these two third pivot assembly couplings 1100. The third passageway 128 travels the entire length from third receptacle first end 400 to third receptacle second end 402. The view on the right side of FIG. 13 illustrates the third slide 112 at an angle. At this angle, the corner of the third slide 112 shared by third receptacle first end 400 and third receptacle first side 404 is in line with the corner of the third slide 112 shared by third receptacle second end 402 and third receptacle second side 406. The fully visible third pivot assembly couplings 1100 partially blocks the other third pivot assembly couplings 1100 behind it.

FIG. 14 illustrates two side views of the fourth slide 114. The left side view illustrates the fourth slide 114 down the central axis of the fourth passageway 130. FIG. 13 illustrates the fourth pivot assembly collar 1200. The width of the fourth pivot assembly collar first inner surface 1206 is greater than the width of the fourth pivot assembly collar second inner surface 1208. The view on the right side of FIG. 14 illustrates the fourth slide 114 at an angle. At this angle, the corner of the fourth slide 114 shared by fourth receptacle first end 412 and fourth receptacle first side 416 is in line with the corner of the fourth slide 114 shared by fourth receptacle second end 414 and fourth receptacle second side 418.

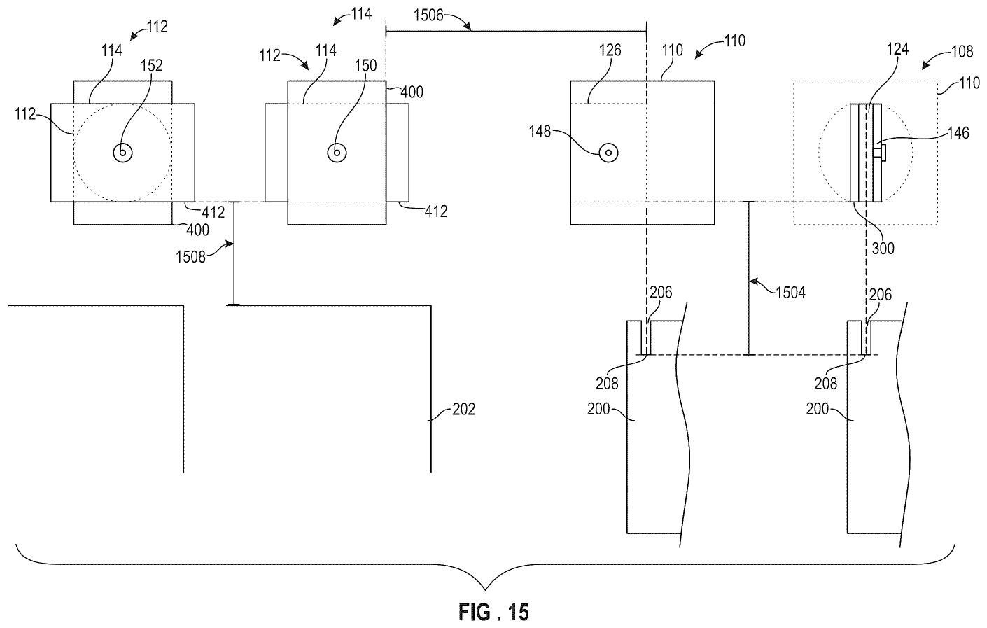

FIG. 15 illustrates a top view of the measurement device 100, the window 200, and the wall 202. The measurement device 100 is in an open configuration, without measurement arms 140, 142, 144. The two views on the right show a top view of the window 200, including the trim track 206, aligned with a top view of the first slide 108 covered by the second slide 110. The trim track 206 is on the same plane as the first passageway 124. The two views in the middle show the window 200, including the trim track 206, aligned with a top view of the second slide 110 covering the first slide 108. The come-out distance 1504 is from the trim track end 208 to the first receptacle first end 300. The two views on the left show a top view of the wall 202 aligned with a top view of the fourth slide 114 covering the third slide 112. The face distance 1506 is from an end of the second passageway 126 to the third receptacle first end 400. The return distance 1508 is from the wall 202 to the fourth receptacle first end 412.

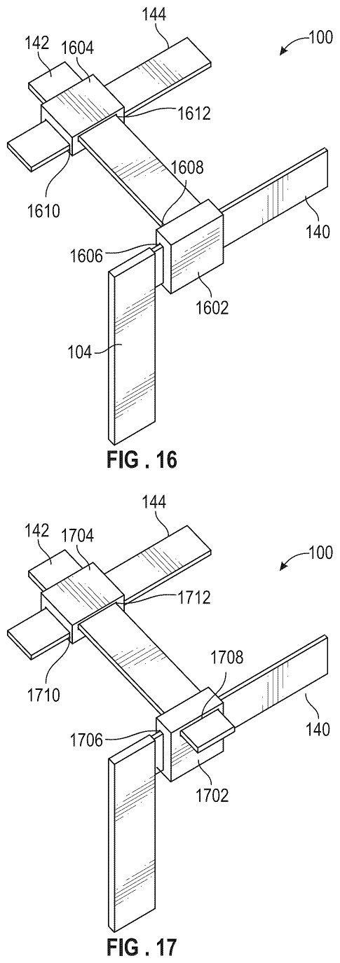

FIG. 16 illustrates an example measurement device 100. This embodiment of the measurement device 100 includes a first double slide 1602 and a second double slide 1604. The first double slide 1602 includes a first double slide first passageway 1606 and a first double slide second passageway 1608. The second double slide 1604 includes a second double slide first passageway 1610 and a second double slide second passageway 1612. The first double slide 1602 may actuate on the first measurement arm 140 by way of the first double slide first passageway 1606. The first double slide second passageway 1608 is a closed-end passageway. The second double slide 1604 may actuate on the second measurement arm 142 by way of the second double slide first passageway 1610. The third measurement arm 144 may actuate through the second double slide second passageway 1612.

FIG. 17 illustrates an example measurement device 100. This embodiment of the measurement device 100 includes a first double slide 1702 and a second double slide 1704. The first double slide 1702 includes a first double slide first passageway 1706 and a first double slide second passageway 1708. The second double slide 1704 includes a second double slide first passageway 1710 and a second double slide second passageway 1712. The first double slide 1702 may actuate on the first measurement arm 140 by way of the first double slide first passageway 1706. The second measurement arm 142 may actuate through the first double slide second passageway 1708. The second double slide 1704 may actuate on the second measurement arm 142 by way of the second double slide first passageway 1710. The third measurement arm 144 may actuate through the second double slide second passageway 1712.

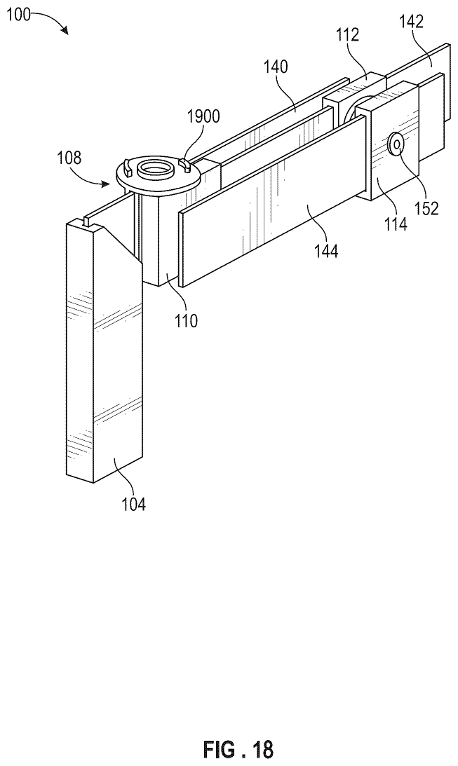

FIG. 18 illustrates an example measurement device 100 that can include three parallel measurement arms. In the embodiment illustrated in FIG. 18, the handle 104 and the first measurement arm 140 are on the same plane. The planes one the second measurement arm 142 and the third measurement arm 144 may become parallel to the planes of the handle 104 and the first measurement arm 140. These planes may become parallel by separating the first slide 108 from the second slide 110 and attaching the second pivot assembly 134 to either the first receptacle first side 304 or the first receptacle second side 306. A storage assembly 1900 may be placed on one or both of the first receptacle first side 304 or the first receptacle second side 306 and used to attach the second slide 110 to the first slide 108. The storage assembly 1900 may be similar to the first pivot assembly couplings 700. Other mechanisms may allow for this attachment. Other embodiments may include a hinge between the first pivot assembly 132 and the first receptacle 116, allowing the handle 104, the first measurement arm 140, the second measurement arm 142, the third measurement arm 144 and the first pivot assembly 132 to be on parallel planes. This feature may allow for easier storage or transportation or the measurement device 100.

Multiple methods may be used to make the second measurement arm 142 and the third measurement arm 144 parallel to the plane of the handle 104 and the first measurement arm 140. These methods may include but are not limited to detaching, folding, and adjusting the measurement device 100. Different combinations of detaching, folding, and adjusting the measurement device 100 may be used. In the embodiment illustrated in FIG. 18 the first slide 108 is separated from the second slide 110 by separating the first pivot assembly 132 and second pivot assembly 134. The second pivot assembly 134 is then attached to the first receptacle first side 304 by attaching to the storage assembly 1900.

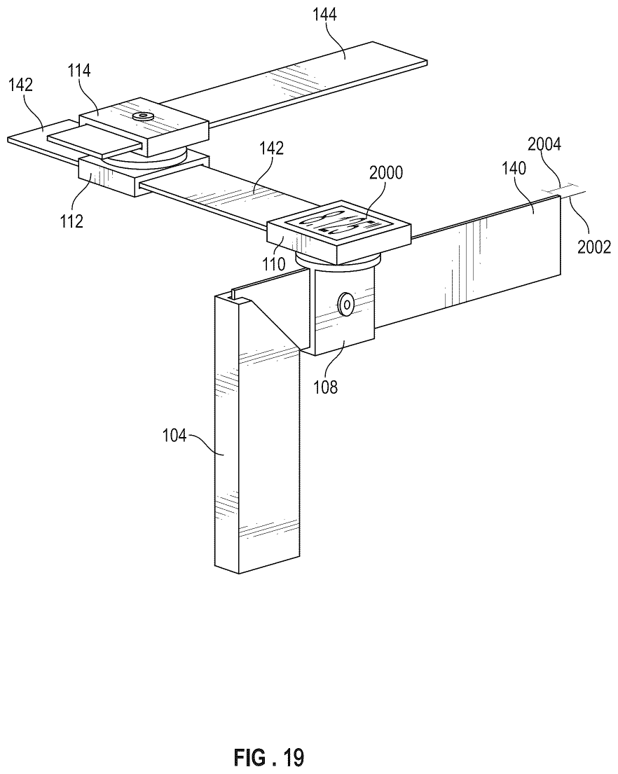

FIG. 19 illustrates an example measurement device 100 including a screen 2000 placed on the second slide 110. This embodiment uses software to calculate measurements. The software may calculate the measurement of the come-out distance 1504, face distance 1506, and return distance 1508. In this embodiment, the software may combine the three measurements into a single combined measurement and display the combined measurement in decimal numbers on the screen 2000. Other embodiments may display the measurement of the come-out distance 1504, face distance 1506, and return distance 1508 separately. Other embodiments may display the measurement of the come-out distance 1504, face distance 1506, and return distance 1508 in fractional numbers. Other embodiments may allow the user of the measurement device 100 to switch between decimal numbers and fractional numbers. Other embodiments may allow the user of the measurement device 100 to switch between showing only one measurement (the come-out distance 1504, the face distance 1506, or the return distance 1508) or the total measurement of the come-out distance 1504, the face distance 1506, the return distance 1508 combined.

FIG. 19 illustrates a measurement arm attachment 2002 that may be attached or detached from the first measurement arm 140. The measurement arm attachment 2002 has a measurement arm attachment distance 2004 that reaches from the trim track end 208 to the first measurement arm 140. The measurement arm attachment 2002 may be thinner and shorter than the first measurement arm 140 ensuring that the measurement device 100 can be used in a multitude of situations including insertion into different sizes and types of trim tracks 206. The measurement arm attachment 2002 may be used for quick and easy insertion into a trim track 206. The measurement arm attachment distance 2004 may be a specific length that can be used to help accurately measure the amount of material needed. For example, a measurement arm attachment 2002 may have a measurement arm attachment distance 2004 of one inch. This may allow the user to add one inch to the come-out distance 1504. Software may detect a measurement arm attachment 2002 and the measurement arm attachment distance 2004 in calculating the correct come-out distance 1504 which includes the measurement arm attachment distance 2004.

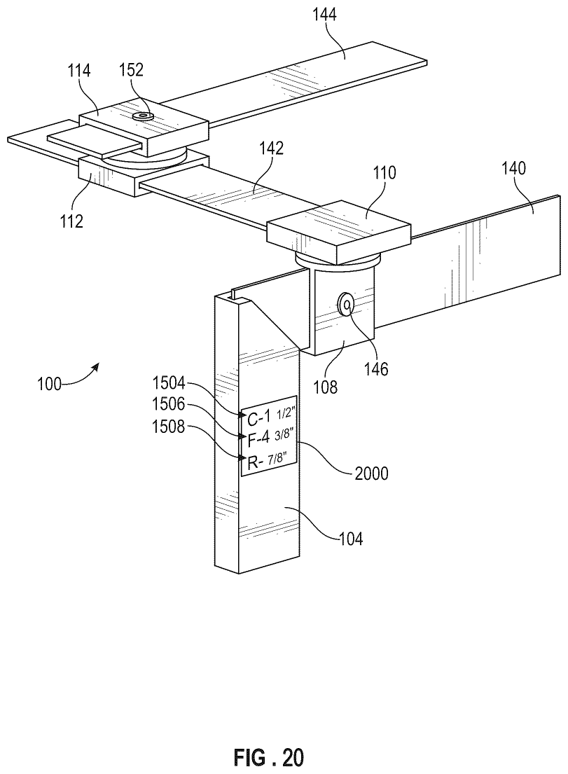

FIG. 20 illustrates an example measurement device 100 including a screen 2000 placed on the handle 104. This embodiment uses software to calculate measurements. The software may calculate the measurement of the come-out distance 1504, face distance 1506, and return distance 1508. In this embodiment, the software may display the three separate measurements of the come-out distance 1504, the face distance 1506, or the return distance 1508 on the screen 2000.

Other embodiments may exist. For example, similar to the embodiment illustrated in FIGS. 1-15, the slides 108, 110, 112, 114 may be in a mated state or a partially mated state. However, the transition between the mated state or the partially mated state may be allowed by movement of the first pivot assembly convex ridges 702 or the third pivot assembly convex ridges 1102 making them flush with the first pivot assembly top surface 712 or the third receptacle top 408, respectively. These convex ridges may be moved by a button, lever, or pressure.

Other embodiments may exist with a different type of clamp 146, 148, 150, 152. These embodiments may be used to secure actuating measurement arms 140, 142, 144. Examples of these different embodiments may include but are not limited to spring loaded set ball-point screws, spring tip set screws, thumb screws, quarter turn fasteners, and spring-loaded fasteners. Embodiments may exist which do not need clamps 146, 148, 150, 152 when passageways are tight enough to hold a measurement arm 140, 142, 144 and loose enough to move a measurement arm 140, 142, 144. Embodiments may exist in which measurement arms 140, 142, 144 are locked in position inside of a passageway by use of glue or other permanent fasteners.

Other embodiments may exist with different types of measurement arms 140, 142, 144. For example, the measurement arms 140, 142, 144 may be expandable and collapsable or may be rolled.

What is claimed is:

1. A measurement device comprising:
a first slide having a first receptacle and a first pivot assembly, wherein the first receptacle defines a first passageway;
a second slide having a second receptacle and a second pivot assembly, wherein the second receptacle defines a second passageway;
a third slide having a third receptacle and a third pivot assembly, wherein the third receptacle defines a third passageway; and
a fourth slide having a fourth receptacle and a fourth pivot assembly, wherein the fourth receptacle defines a fourth passageway;
wherein the first pivot assembly is mated with the second pivot assembly to pivotally attach the first slide to the second slide;
wherein the third pivot assembly is mated with the fourth pivot assembly to pivotally attach the third slide to the fourth slide;
wherein the first slide is movably disposed on a first measurement arm;
wherein the third slide is movably disposed on a second measurement arm; and
wherein the fourth slide is movably disposed on a third measurement arm.

2. The measurement device of claim 1, wherein the first pivot assembly and the second pivot assembly are joined by couplings on the first pivot assembly in contact with a collar on the second pivot assembly.

3. The measurement device of claim 1, wherein the third pivot assembly and the fourth pivot assembly are joined by couplings on the third pivot assembly in contact with a collar on the fourth pivot assembly.

4. The measurement device of claim 1, wherein the first pivot assembly and the second pivot assembly are in a mated position at increments in rotation.

5. The measurement device of claim 1, wherein the first pivot assembly comprises a convex ridge and the second pivot assembly comprises a concave groove, and wherein the convex ridge is inserted into the concave groove such that the first pivot assembly and the second pivot assembly are in a mated position.

6. The measurement device of claim 1, wherein the first pivot assembly comprises a convex ridge and the second pivot assembly comprises a concave groove, and wherein the convex ridge is extracted from the concave groove such that the first pivot assembly and the second pivot assembly are in a partially mated position.

7. The measurement device of claim 1, wherein the first passageway and the second passageway are on orthogonal planes.

8. The measurement device of claim 1, wherein the first pivot assembly and the second pivot assembly are in a mated position at angled increments of equal to or greater than 80 degrees and less than or equal to 100 degrees in rotation.

9. The measurement device of claim 1, wherein the third pivot assembly and the fourth pivot assembly are in a mated position at angled increments of equal to or greater than 80 degrees and less than or equal to 100 degrees in rotation.

10. The measurement device of claim 1, wherein the first measurement arm is configured to insert into a trim track along the exterior of a window.

11. The measurement device of claim 10, wherein the first measurement arm includes a measurement arm attachment configured to insert into the trim track.

12. A measurement device comprising:
a first slide comprising a first receptacle and a first pivot assembly, wherein the first receptacle defines a first passageway;
a second slide comprising a second receptacle and a second pivot assembly, wherein the second receptacle defines a second passageway;
a third slide comprising a third receptacle and a third pivot assembly, wherein the third receptacle defines a third passageway; and
a fourth slide comprising a fourth receptacle and a fourth pivot assembly, wherein the fourth receptacle defines a fourth passageway;
wherein the first pivot assembly and the second pivot assembly are attached and independently rotatable;
wherein the third pivot assembly and the fourth pivot assembly are attached and independently rotatable;
wherein the first slide and second slide are in a mated position when the measurement device is in an open configuration and in a closed configuration;
wherein the third slide and fourth slide are in a mated position when the measurement device is in an open configuration and in a closed configuration;
wherein the first pivot assembly and the second pivot assembly are in a mated position at angles of equal to or greater than 80 degree increments and less than or equal to 100 degree increments in rotation and in a partially mated position between the angles of equal to or greater than 80 degree increments and less than or equal to 100 degree increments in rotation; and
wherein the third pivot assembly and the fourth pivot assembly are in a mated position at angles of equal to or greater than 80 degree increments and less than or equal to 100 degree increments in rotation and in a partially mated position between the angles of equal to or greater than 80 degree increments and less than or equal to 100 degree increments in rotation.

13. The measurement device of claim 12, wherein the first pivot assembly and the second pivot assembly are joined by couplings on the first pivot assembly in contact with a collar on the second pivot assembly.

14. The measurement device of claim 12, wherein the third pivot assembly and the fourth pivot assembly are joined by couplings on the third pivot assembly in contact with a collar on the fourth pivot assembly.

15. The measurement device of claim 12, wherein the first pivot assembly and the second pivot assembly are in a mated position at increments in rotation.

16. The measurement device of claim 12, wherein the first pivot assembly comprises a convex ridge and the second pivot assembly comprises a concave groove, and wherein the convex ridge is inserted into the concave groove such that the first pivot assembly and the second pivot assembly are in a mated position.

17. The measurement device of claim 12, wherein the first pivot assembly comprises a convex ridge and the second pivot assembly comprises a concave groove, and wherein the convex ridge is extracted from the concave groove such that the first pivot assembly and the second pivot assembly are in a partially mated position.

18. The measurement device of claim 12, wherein the first passageway and the second passageway are on orthogonal planes.

19. A measurement device comprising:
a handle;
a first measurement arm disposed on the handle;
a second measurement arm;
a third measurement arm;
a first slide having a first passageway;
a second slide having a second passageway;
a third slide having a third passageway; and
a fourth slide having a fourth passageway;
wherein a pivot assembly of the first slide is attached to a pivot assembly of the second slide;
wherein a pivot assembly of the third slide is attached to a pivot assembly of the fourth slide;
wherein the first slide is movably disposed on the first measurement arm;
wherein the second slide and third slide are movably disposed on the second measurement arm;
wherein the fourth slide is movably disposed on the third measurement arm;
wherein the first measurement arm is configured to fit within a trim track of a window and make contact with an end of the trim track;
wherein the third measurement arm is configured to make contact with an exterior of a building;
wherein the measurement device may pivot from an open configuration to a closed configuration; and
wherein in the open configuration, a central axis of the first measurement arm is parallel to a central axis of the third measurement arm, while a central axis of the second measurement arm is perpendicular to the first measurement arm and the third measurement arm.

20. The measurement device of claim 19, wherein the first pivot assembly and the second pivot assembly are in a mated position at angled increments of equal to or greater than 80 degrees and less than or equal to 100 degrees in rotation.
